(19) United States
(12) Patent Application Publication
(10) Pub. No.: US 2002/0002984 A1
(43) Pub. Date: Jan. 10, 2002

(54) Surgical scrub brush and method

(76) Inventor: Randall A. Loy, Longwood, FL (US)

Correspondence Address: Allen, Dyer, Doppelt, Milbrath & Gilchrist, P.A., 255 South Orange Avenue, Suite 1401, P.O. Box 3791, Orlando, FL, 32802-3791, US

(21) Appl. No.: 09/842,205

(22) Filed: Apr. 25, 2001

Related U.S. Application Data
(60) Provisional application No. 60/199,640, filed on Apr. 25, 2000.

(51) Int. Cl. A47K 7/04; B08B 1/00

(52) U.S. Cl. 134/6; 15/104.94; 15/106; 15/114; 15/160; 15/167.3

(57) ABSTRACT

A surgical scrub brush for improved hand cleaning prior to and during surgery includes a unitary device with a generally flat base. The base has bristles affixed thereto to at least one portion of the periphery thereof. The periphery is shaped for optimal accessibility to the interdigital hand area. Preferably the brush also includes an absorbent sponge portion adapted to hold a cleansing fluid, such as a soap solution.

### CROSS-REFERENCE TO RELATED APPLICATION

This application claims priority from provisional application Ser. No. 60/199,430, filed Apr. 25, 2000, entitled “Thermometer and Method.”

### BACKGROUND OF THE INVENTION

1. Field of the Invention

The present invention relates to surgical cleansing devices and methods, and, more particularly, to such devices and methods for cleaning the hands.

2. Description of Related Art

Preparatory to and during surgery, the surgical team must take considerable pains to avoid contamination. Part of this process involves cleaning the hands, a particular portion of which, the interdigital “web” area between the fingers, is known to be difficult to address adequately.

Surgical brushes are known in the art that have different types of bristles and/or surfaces for different areas of the hand (U.S. Pat. Nos. 3,966,335, 4,480,351, and 5,312,197) and also having a cleansing solution compartment (U.S. Pat. Nos. 4,880,111 and 5,312,197).

### SUMMARY OF THE INVENTION

It is therefore an object of the present invention to provide an improved surgical scrub brush.

It is an additional object to provide such a brush that is adapted for reaching the web area of the hands.

It is a further object to provide such a brush that has means for containing a cleansing solution.

These objects and others are attained by the present invention, a surgical scrub brush adapted for improved hand cleaning prior to and during surgery. The brush comprises a unitary device comprising a generally flat base having a plurality of cleaning means affixed thereto along different portions of the periphery thereof, the periphery shaped for optimal accessibility to the interdigital hand area. Preferably the brush also comprises an absorbent portion adapted to hold a cleansing fluid, such as a soap solution.

The features that characterize the invention, both as to organization and method of operation, together with further objects and advantages thereof, will be better understood from the following description used in conjunction with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### BRIEF DESCRIPTION OF THE DRAWINGS

FIG. 1 is a top plan view of a first embodiment of the surgical scrub brush.

FIG. 2 is a top plan view of a second embodiment of the surgical scrub brush.

### DETAILED DESCRIPTION OF THE PREFERRED EMBODIMENTS

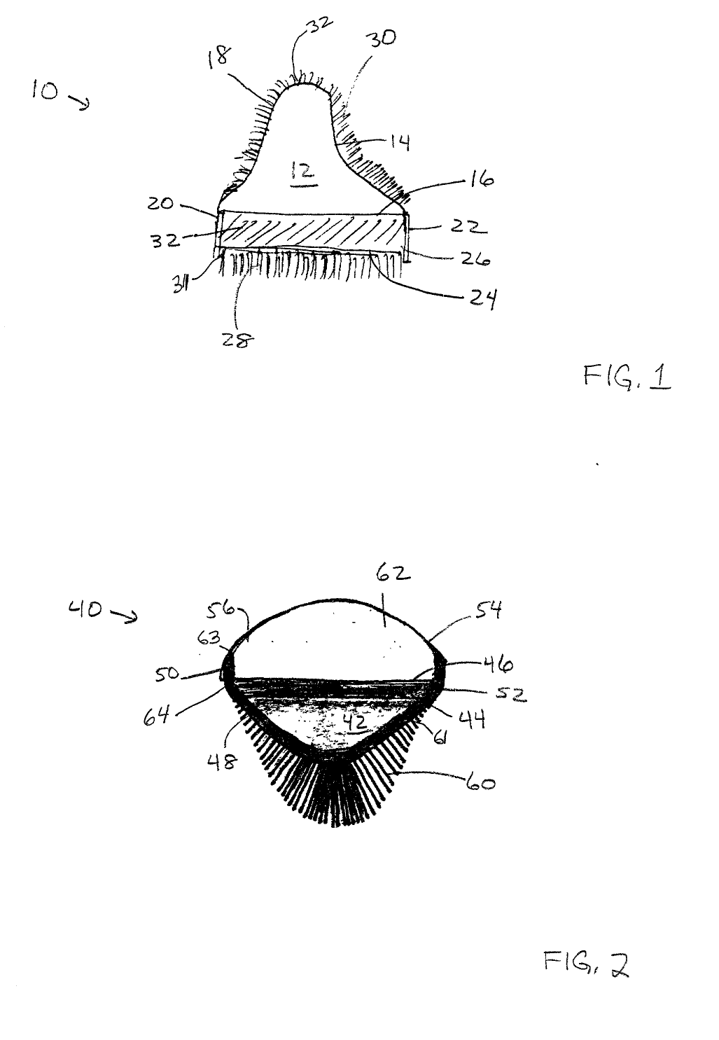

A description of the preferred embodiments of the present invention will now be presented with reference to FIGS. 1 and 2.

A first embodiment of the scrub brush 10 of the present invention is illustrated in FIG. 1. The brush 10 in a preferred embodiment comprises a molded plastic base 12. The base 12 is substantially flat and adapted for holding securely in one hand.

The periphery 14 of the base comprises two sections: a first, substantially front face 16; and a generally sigmoidal side and rear 18 extending away from the first section 16. A first 20 and a second 22 substantially planar support member each extends perpendicular to the front face 16 from the corners at which the front face 16 joins the side and rear face 18. The planar support members 20, 22 are generally parallel to each other. A third substantially linear support member 24 joins the first 20 and second 22 support members at approximately right angles to form a substantially rectangular enclosure 26 with the base first section 16.

To the third support member 24 front face 16 are attached a plurality of a first set of bristles 28 at their ends 31. The first set of bristles 28 are generally adapted for cleaning the fingernails. To the base side and rear face 18 are affixed a second set of bristles 30 at their ends 32, generally adapted for cleaning the interdigital area between the fingers.

Within the enclosure 26 to the support members 20, 22, 24 and the base first section 16 is affixed a sponge member 32 that is for assisting in the cleansing process, and may in a particular embodiment be impregnated with a cleaning composition such as soap.

A second embodiment of the scrub brush 40 of the present invention is illustrated in FIG. 2. The brush 40 in a preferred embodiment also comprises a molded plastic base 42. The base 42 is substantially flat and adapted for holding securely in one hand.

The periphery 44 of the base comprises two sections: a first, substantially planar rear face 46; and an outwardly arched side and front face 48 extending away from the rear face 46. A first 50 and a second 52 substantially planar support member each extends approximately perpendicular to the rear face 46, joining the ends of the rear face 46 at a first end 64. The planar support members 50, 52 are generally parallel to each other. A third arched support member 54 joins the first 50 and second 52 support members at their second ends 63 to form a substantially half-oval enclosure 56 with the base rear face 46.

To the side and front face 48 are affixed a plurality of bristles 60 at an end 61, generally adapted for cleaning the interdigital area between the fingers.

Within the enclosure 56 to the support members 50, 52, 54 and to the base first section 46 is affixed a sponge member 62 that is for assisting in the cleansing process, and may in a particular embodiment be impregnated with a cleaning composition such as soap.

It may be appreciated by one skilled in the art that additional embodiments may be contemplated, including various alternative base shapes adapted for improved cleaning characteristics from the prior art.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the apparatus illustrated and described herein are by way of example, and the scope of the invention is not limited to the exact details of construction.

Having now described the invention, the construction, the operation and use of preferred embodiments thereof, and the advantageous new and useful results obtained thereby, the new and useful construction, and reasonable mechanical equivalents thererof obvious to those skilled in the art, are set forth in the appended claims.

What is claimed is:

1. A surgical scrub brush comprising:
a substantially flat base dimensioned for being held in a human hand, the base having a substantially planar front face and a side and rear face extending away from the front face and having a generally sigmoidal shape;
a first and a second substantially planar support member extending approximately perpendicular to the front face, one support member extending from each corner at which the front face meets the side and rear face;
a third substantially planar support member having opposed ends, one end joining a front end of one of the first and the second support member;
a first set of bristles affixed at an end thereof to a front face of the third support member, the first set of bristles adapted for cleaning fingernails;
a second set of bristles affixed at an end thereof to the side and rear face of the base, the second set of bristles adapted for cleaning an interdigital area of the hand; and
a sponge member affixed within an enclosure formed by the base front face and the first, the second, and the third support members.

2. The brush recited in claim 1, further comprising a cleaning composition impregnated within the sponge member.

3. The brush recited in claim 1, wherein the first set of bristles are longer than the second set of bristles.

4. The brush recited in claim 1, wherein the base comprises a molded plastic.

5. A method of cleaning a hand comprising the steps of:
holding a scrub brush in a first hand, the brush comprising:
a substantially flat base, the base having a substantially planar front face and a side and rear face extending away from the front face and having a generally sigmoidal shape;
a first and a second substantially planar support member extending approximately perpendicular to the front face, one support member extending from each corner at which the front face meets the side and rear face;
a third substantially planar support member having opposed ends, one end joining a front end of one of the first and the second support member;
cleaning the fingernails of a second hand with a first set of bristles affixed at an end thereof to a front face of the third support member;
cleaning an interdigital area of the hand with a second set of bristles affixed at an end thereof to the side and rear face of the base; and
cleaning skin of the hand with a sponge member affixed within an enclosure formed by the base front face and the first, the second, and the third support members.

6. The method recited in claim 5, wherein the skin cleaning step further comprises cleaning with soap impregnated in the sponge.

7. A surgical scrub brush comprising:
a substantially flat base dimensioned for holding in a human hand, the base having a substantially planar rear face and an outwardly arched side and front face extending away from the rear face;
a first and a second substantially planar support member extending approximately perpendicular to the rear face, one support member extending from each end of the rear face at a first end;
a third arched support member having opposed ends, one end joining a second end of one of the first and the second support member to form an enclosure with the rear face;
a set of bristles affixed at an end thereof to the side and front face, the set of bristles adapted for cleaning an interdigital area of the hand; and
a sponge member affixed within the enclosure.

8. The brush recited in claim 7, wherein the base comprises a molded plastic.

9. The brush recited in claim 7, further comprising a cleansing composition impregnating the sponge.

10. A method of cleaning a hand comprising the steps of:
holding a scrub brush in a first hand, the brush comprising:
a substantially flat base having a substantially planar rear face and an outwardly arched side and front face extending away from the rear face;
a first and a second substantially planar support member extending approximately perpendicular to the rear face, one support member extending from each end of the rear face at a first end; and
a third arched support member having opposed ends, one end joining a second end of one of the first and the second support member to form an enclosure with the rear face;
cleaning an interdigital area of the hand with a set of bristles affixed at an end thereof to the side and front face; and
cleaning skin of the hand with a sponge member affixed within the enclosure.
